(19) United States
(12) Patent Application Publication
(10) Pub. No.: US 2020/0077770 A1
(43) Pub. Date: Mar. 12, 2020

(54) MOBILE DEVICE FOR BROADCASTING VIDEO CONTENT WITH HOLOGRAPHIC EFFECT

(71) Applicant: Im Oudom Khim, Paris (FR)

(72) Inventor: Im Oudom Khim, Paris (FR)

(21) Appl. No.: 16/567,867

(22) Filed: Sep. 11, 2019

(30) Foreign Application Priority Data
Sep. 11, 2018 (FR) 1871016
Aug. 29, 2019 (FR) 1909512

(51) Int. Cl. A45F 3/04; H04N 13/393

(52) U.S. Cl. CPC A45F 3/04; A45F 2003/001; H04N 13/393

(57) ABSTRACT

Mobile and standalone device for broadcasting video content with 3D rendering through a holographic LED propeller comprising a backpack with straps and a mast for fixing the holographic LED propeller.

The present invention relates to the broadcasting of video content with 3D rendering through a holographic LED propeller.

More particularly a mobile and standalone device for making it possible to broadcast video content with 3D rendering through a holographic LED propeller.

The broadcasting of video content with 3D rendering is traditionally performed at a specific, fixed location, with an electrical power supply from the network of the electricity provider, which limits the message broadcasting range to a restricted space.

A device is therefore proposed for the direct communication, in locations of common and private spaces, of video content with 3D rendering through a holographic propeller.

The invention relates to a mobile and standalone device for broadcasting video content with 3D rendering through a holographic LED propeller comprising a backpack with straps and a mast for fixing the holographic LED propeller.

According to one embodiment, the device comprises two holographic LED propellers.

Advantageously, the device can comprise at least one external battery.

Preferably, it comprises two external batteries of 50,000 mA power, each disposed in an internal pocket of the backpack.

According to a feature, the mast can be a hollow aluminum mast configured for the passage of power supply cables linking the holographic propeller to the external batteries.

Preferably, the device comprises an expansive foam internal to the backpack to keep the internal system of the backpack immobile.

Advantageously, the backpack comprises a system of vertical and horizontal straps.

Furthermore, the device can comprise a transparent plexiglass protection.

The transparent plexiglass protection can be open at the front.

Preferably, the device comprises an integrated portable speaker for a broadcast through the backpack, the backpack also comprising a sewn acoustic fabric.

Other aims, advantages and features will emerge from the following description given in a purely illustrative manner and with reference to the attached drawings in which:

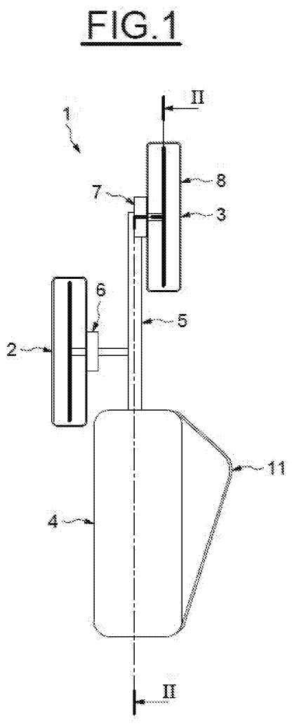

FIG. 1 represents a side view of a mobile and standalone device for broadcasting video content with 3D rendering through a holographic LED propeller according to the invention.

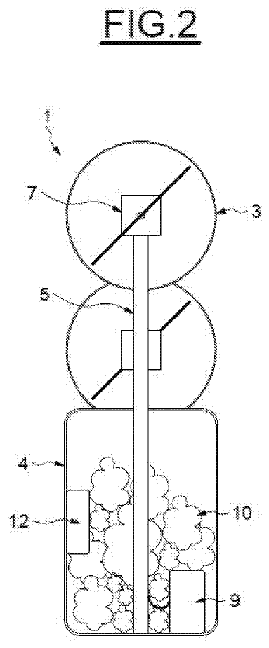

FIG. 2 represents a cross-sectional view of the device illustrated in FIG. 1 along the axis II-II.

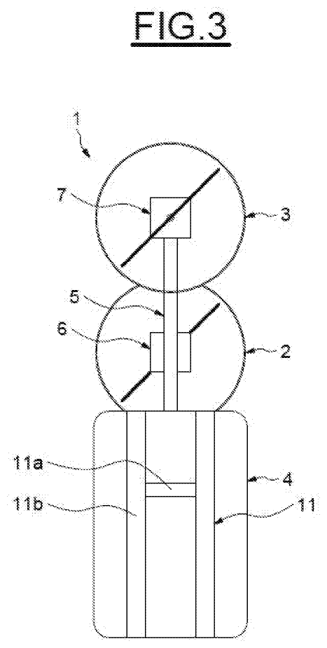

FIG. 3 represents a rear view of the device illustrated in FIG. 1.

FIGS. 1 to 3 illustrate a mobile and standalone device 1 for broadcasting video content with 3D rendering through a holographic LED propeller according to the invention.

The device allows the holographic communication to be made mobile because it comprises a means for transporting a holographic LED propeller 2, 3.

The transport means includes a backpack 4 with straps, preferably a “long” backpack of a height greater than 50 cm, and a mast 5 for fixing the propeller 2, 3.

As illustrated in the figures, the mobile device 1 can comprise two holographic propellers 2 and 3, for example for the simultaneous broadcast of a communication to the front and a communication to the rear relative to the individual carrying the device 1.

According to another embodiment that is not illustrated, the device 1 will be able to comprise more than two propellers.

In the example illustrated, the mast 5 is a hollow aluminum mast with, preferably, two square plates 6 and 7 forming fixing supports allowing the passage of power supply cables, the cables being then concealed in the mast 5, and the fixing of the two holographic propellers 2 and 3.

The mast 5 also increases the visibility of the communications broadcast through the propellers 2 and 3.

The propellers 2 and 3 can be protected by a circular plexiglass screen or protection 8 both at the front and the rear and securing the system. The transparent plexiglass protection 8 can be open at the front for better visibility of the holographic projection.

In the example illustrated, the device 1 advantageously comprises at least one external battery 9.

For example, the propellers can be powered by two batteries 9 of 50,000 mA power, with a usage time of 5 hours, each disposed in an internal pocket of the backpack 4.

The power supply cables link the holographic propeller 2, 3 to the external batteries 9.

Furthermore, the device 1 as a whole is held within the backpack 4 by expansive foam 10. The expansive foam 10 internal to the backpack 4 makes it possible to keep the internal system of the backpack 4 immobile.

Moreover, the backpack 4 comprises a system of vertical and horizontal straps 11. The system 11 of vertical straps 11a and horizontal straps 11b allows for a stable use of the system 11 by the individual carrying the device.

According to one embodiment, a portable speaker 12 can be incorporated for a more impactful communication. The broadcasting is done through the backpack 4 in which an acoustic fabric will have been previously sewn.

1. Mobile and standalone device for broadcasting video content with 3D rendering through a holographic LED propeller comprising a backpack with straps and a mast for fixing the holographic LED propeller.

2. Device according to claim 1, characterized in that it comprises two holographic LED propellers.

3. Device according to claim 1, characterized in that it comprises at least one external battery.

4. Mobile device according to claim 3, characterized in that it comprises two external batteries of 50,000 mA power, each disposed in an internal pocket of the backpack.

5. Device according to claim 3, characterized in that the mast is a hollow aluminum mast configured for the passage of power supply cables linking the holographic propeller to the external batteries.

6. Device according to claim 1, characterized in that it comprises an expansive foam internal to the backpack to keep the internal system of the backpack immobile.

7. Device according to claim 1, characterized in that the backpack comprises a system of vertical and horizontal straps.

8. Device according to claim 1, characterized in that it comprises a transparent plexiglass protection.

9. Device according to claim 8, characterized in that the transparent plexiglass protection is open at the front.

10. Device according to claim 1, characterized in that it comprises an integrated portable speaker for a broadcast through the backpack, the backpack also comprising a sewn acoustic fabric.
